(19) United States
(12) Patent Application Publication
(10) Pub. No.: US 2017/0277952 A1
(43) Pub. Date: Sep. 28, 2017

(54) METHOD AND AXLE-COUNTING DEVICE FOR CONTACT-FREE AXLE COUNTING OF A VEHICLE AND AXLE-COUNTING SYSTEM FOR ROAD TRAFFIC

(71) Applicant: JENOPTIK Robot GmbH, Monheim (DE)

(72) Inventors: Jan THOMMES, Hannover (DE); Dima PROEFROCK, Hildesheim (DE); Michael LEHNING, Hildesheim (DE); Michael TRUMMER, Hildesheim (DE)

(73) Assignee: JENOPTIK Robot GmbH, Monheim (DE)

(21) Appl. No.: 15/505,797

(22) PCT Filed: Aug. 17, 2015
(86) PCT No.: PCT/EP2015/001688

§ 371 Date: Feb. 22, 2017

(30) Foreign Application Priority Data
Aug. 22, 2014 (DE) 10 2014 012 285.9

(51) Int. Cl. G06K 9/00; G08G 1/056

(52) U.S. Cl. CPC G06K 9/00651; G06K 9/00825; G06K 9/00818; G06K 9/00798; G08G 1/056; G06T 2207/30236; G06T 2207/30242; G06T 7/60

(57) ABSTRACT

A method for contact-free axle counting of a vehicle on a road, including a step of reading in first image data and reading in second image data, wherein the first image data and/or the second image data represent image data provided to an interface by an image data recording sensor arranged on a side of the road. The first image data and/or the second image data comprise an image of the vehicle. The first image data and/or the second image data is processed in order to obtain processed first image data and/or processed second image data. By using the first image data and/or the second image data in a substep of detecting, at least one object is detected in the first image data and/or the second image data, and wherein object information is provided representing the object and assigned to the first image data and/or the second image data.

This nonprovisional application is a National Stage of International Application No. PCT/EP2015/001688, which was filed on Aug. 17, 2015, and which claims priority to German Patent Application No. 10 2014 012 285.9, which was filed in Germany on Aug. 22, 2014, and which are both herein incorporated by reference.

### BACKGROUND OF THE INVENTION

### Field of the Invention

The present invention relates to a method for counting axles of a vehicle on a lane in a contactless manner, an axle-counting apparatus for counting axles of a vehicle on a lane in a contactless manner, a corresponding axle-counting system for road traffic and a corresponding computer program product.

### Description of the Background Art

Road traffic is monitored by metrological devices. Here, systems may e.g. classify vehicles or monitor speeds. Induction loops embedded in the lane may be used to realize contactless axle-counting systems.

EP 1 480 182 81 discloses a contactless axle-counting system for road traffic.

### SUMMARY OF THE INVENTION

Against this background, the present invention presents an improved method for counting axles of a vehicle on a lane in a contactless manner, an axle-counting apparatus for counting axles of a vehicle on a lane in a contactless manner, a corresponding axle-counting system for road traffic and a corresponding computer program product in accordance with the main claims. Advantageous configurations emerge from the respective dependent claims and the following description.

A traffic monitoring system also serves to enforce rules and laws in road traffic. A traffic monitoring system may determine the number of axles of a passing vehicle and, optionally, assign these as rolling axles or static axles. Here, a rolling axle may be understood to mean a loaded axle and a static axle may be understood to mean an unloaded axle or an axle lifted off the lane. In optional development stages, a result may be validated by a second image or an independent second method.

A method for counting axles of a vehicle on a lane in a contactless manner comprises the following steps:
reading first image data and reading second image data, wherein the first image data and additionally, or alternatively, the second image data represent image data from an image data recording sensor arranged at the side of the lane, said image data being provided at an interface, wherein the first image data and additionally, or alternatively, the second image data comprise an image of the vehicle;
editing the first image data and additionally, or alternatively, the second image data in order to obtain edited first image data and additionally, or alternatively, edited second image data, wherein at least one object is detected in the first image data and additionally, or alternatively, the second image data in a detecting sub-step using the first image data and additionally, or alternatively, the second image data and wherein an object information item representing the object and assigned to the first image data and additionally, or alternatively, second image data is provided and wherein the at least one object is tracked in time in the image data in a tracking sub-step using the object information item and wherein the at least one object is identified and additionally, or alternatively, classified in a classifying sub-step using the object information item; and
determining a number of axles of the vehicle and additionally, or alternatively, assigning the axles to static axles of the vehicle and rolling axles of the vehicle using the edited first image data and additionally, or alternatively, the edited second image data and additionally, or alternatively, the object information item assigned to the edited image data in order to count the axles of the vehicle in a contactless manner.

Vehicles may move in a lane. The lane may be a constituent of the road, and so a plurality of lanes may be arranged in parallel. Here, a vehicle may be understood to be an automobile or a commercial vehicle such as a bus or truck. A vehicle may be understood to mean a trailer. Here, a vehicle may also comprise a trailer or semitrailer. Thus, a vehicle may be understood to mean a motor vehicle or a motor vehicle with a trailer. The vehicles may have at least two axles. A motor vehicle may have at least two axles. A trailer may have at least one axle. Thus, axles of a vehicle may be assigned to a motor vehicle or a trailer which can be assigned to the motor vehicle. The vehicles may also have a multiplicity of axles, wherein some of these may be unloaded. Unloaded axles may have a distance from the lane and not exhibit rotational movement. Here, axles may be characterized by wheels, wherein the wheels of the vehicle may roll on the lane or, in an unloaded state, be at a distance from the lane. Thus, static axles may be understood to mean unloaded axles. An image data recording sensor may be understood to mean a stereo camera, a radar sensor or a mono camera. A stereo camera may be embodied to create an image of the surroundings in front of the stereo camera and provide this as image data. A stereo camera may be understood to mean a stereo image camera. A mono camera may be embodied to create an image of the surroundings in front of the mono camera and provide this as image data. The image data may also be referred to as image or image information item. The image data may be provided as a digital signal from the stereo camera at an interface. A three-dimensional reconstruction of the surroundings in front of the stereo camera may be created from the image data of a stereo camera. The image data may be preprocessed in order to simplify or facilitate an evaluation. Thus, various objects may be recognized or identified in the image data. The objects may be classified. Thus, a vehicle may be recognized and classified in the image data as an object. Thus, the wheels of the vehicle may be recognized and classified as an object or as a partial object of an object. Here, wheels of the vehicle may searched and determined in a camera image or the image data. An axle may be deduced from an image of a wheel. An information item about the object may be provided as image information item or object information item. Thus, the object information item may comprise, for example, an information item about a position, a location, a velocity, a movement direction, an object classification or the like. An object information item may be assigned to an image or image data or edited image data.

In the reading step, the first image data may represent first image data captured at a first instant and the second image data may represent image data captured at a second instant differing from the first instant. In the reading step, the first image data may represent image data captured from a first viewing direction and the second image data may represent image data captured from a second viewing direction. The first image data and the second image data may represent image data captured by a mono camera or a stereo camera. Thus, an image or an image pair may be captured and processed at one instant. Thus, in the reading step, first image data may be read at a first instant and second image data may be read at a second instant differing from the first instant.

By way of example, the following variants for the image data recording sensor and further sensor system, including the respective options for data processing, may be used as one aspect of the concept presented here. A single image may be recorded if a mono camera is used as image data recording sensor. Here, it is possible to apply methods which do not require any 3D information, i.e. a purely 2D single image analysis. An image sequence may be read and processed in a complementary manner. Thus, methods for a single image recording may be used, just like, furthermore, 3D methods which are able to operate with unknown scaling may be used as well. Furthermore, a mono camera may be combined with a radar sensor system. Thus, a single image of a mono camera may be combined with a distance measurement. Thus, a 2D image analysis may be enhanced with additional information items or may be validated. Advantageously, an evaluation of an image sequence may be used together with a trajectory of the radar. Thus, it is possible to carry out a 3D analysis with correct scaling. If use is made of a stereo camera for recording the first image data and the at least second image data, it is possible to evaluate a single (double) image, just like, alternatively, a (double) image sequence with functions of a 2/3D analysis may be evaluated as well. A stereo camera as an image recording sensor may be combined with a radar sensor system and functions of a 2D analysis or a 3D analysis may be applied to the measurement data. In the described embodiments, a radar sensor system or a radar may be replaced in each case by a non-invasive distance-measuring sensor or a combination of non-invasively acting appliances which satisfy this object.

The method may be preceded by preparatory method steps. Thus, in preparing fashion, the sensor system may be transferred into a state of measurement readiness in a step of self-calibration. Here, the sensor system may be understood to mean at least the image recording sensor. Here, the sensor system may be understood to mean at least the stereo camera. Here, the sensor system may be understood to mean a mono camera, the alignment of which is established in relation to the road. In optional extensions, the sensor system may also be understood to mean a different imaging or distance-measuring sensor system. Furthermore, the stereo camera or the sensor system optionally may be configured for the traffic scene in an initialization step. An alignment of the sensor system in relation to the road may be known as a result of the initialization step.

In the reading step, further image data may be read at the first instant and additionally, or alternatively, the second instant and additionally, or alternatively, a third instant differing from the first instant and additionally, or alternatively, the second instant. Here, the further image data may represent an image information item captured by a stereo camera and additionally, or alternatively, a mono camera and additionally, or alternatively, a radar sensor system. In a summarizing and generalizing fashion, a mono camera, a stereo camera and a radar sensor system may be referred to as a sensor system. A radar sensor system may also be understood to mean a non-invasive distance-measuring sensor. In the editing step, the image data and the further image data may be edited in order to obtain edited image data and additionally, or alternatively, further edited image data. In the determining step, the number of axles of the vehicle or the assignment of the axles to static axles or rolling axles of the vehicle may take place using the further edited image data or the object information item assigned to the further edited image data. Advantageously, the further image data may thus lead to a more robust result. Alternatively, the further image data may be used for validating results. A use of a data sequence, i.e. a plurality of image data which were captured at a plurality of instants, may be expedient within the scope of a self-calibration, a background estimation, stitching and a repetition of steps on individual images. In these cases, more than two instants may be relevant. Thus, further image data may be captured at at least one third instant.

The editing step may comprise a step of homographic rectification. In the step of homographic rectification, the image data and additionally, or alternatively, image data derived therefrom may be rectified in homographic fashion using the object information item and may be provided as edited image data such that a side view of the vehicle is rectified in homographic fashion in the edited image data. In particular, a three-dimensional reconstruction of the object, i.e. of the vehicle, may be used to provide a view or image data by calculating a homography, as would be available as image data in the case of an orthogonal view onto a vehicle side or the image of the vehicle. Advantageously, wheels of the axles may be depicted in a circular fashion and rolling axles may be reproduced at one and same height the homographic edited image data. Static axles may have a height deviating therefrom.

Further, the editing step may comprise a stitching step, wherein at least two items of image data are combined from the first image data and additionally, or alternatively, the second image data and additionally, or alternatively, first image data derived therefrom and additionally, or alternatively, second image data derived therefrom and additionally, or alternatively, using the object information item and said at least two items of image data are provided as first edited image data. Thus, two images may be combined to form one image. By way of example, an image of a vehicle may extend over a plurality of images. Here, overlapping image regions may be identified and superposed. Similar functions may be known from panoramic photography. Advantageously, an image in which the vehicle is imaged completely may also be created in the case of a relatively small distance between the capturing device such as e.g. a stereo camera and the imaged vehicle and in the case of relatively long vehicles. Advantageously, as a result of this, a distance between the lane and the stereo camera may be smaller than in the case without using stitching or image-distorting wide-angle lenses. Advantageously, an overall view of the vehicle may be generated from the combined image data, said overall view offering a constant high local pixel resolution of image details in relation to a single view.

The editing step may comprise a step of fitting primitives in the first image data and additionally, or alternatively, in the second image data and additionally, or alternatively, first image data derived therefrom and additionally, or alternatively, second image data derived therefrom in order to provide a result of the fitted and additionally, or alternatively, adopted primitives as object information item. Primitives may be understood to mean, in particular, circles, ellipses or segments of circles or ellipses. Here, a quality measure for matching a primitive to an edge contour may be determined as object information item. Fitting a circle in a transformed side view, i.e. in edited image data, for example by a step of homographic rectification, may be backed by fitting ellipses in the original image, i.e. in the image data, to the corresponding point. A clustering of center point estimates of the primitives may indicate an increased probability of a wheel center point and hence of an axle.

It is also expedient if the editing step comprises a step of identifying radial symmetries in the first image data and additionally, or alternatively, in the second image data and additionally, or alternatively, first image data derived therefrom and additionally, or alternatively, second image data derived therefrom in order to provide a result of the identified radial symmetries as object information item. The step of identifying radial symmetries may comprise pattern recognition by means of accumulation methods. By way of example, transformations in polar coordinates may be carried out for candidates of centers of symmetries, wherein, translational symmetries may arise in the polar representation. Here, translational symmetries may be identified by means of a displacement detection. Evaluated candidates for center points of radial symmetries, which indicate axles, may be provided as object information item.

Further, the editing step may comprise a step of classifying a plurality of image regions using at least one classifier in the first image data and additionally, or alternatively, in the second image data and additionally, or alternatively, first image data derived therefrom and additionally, or alternatively, second image data derived therefrom in order to provide a result of the classified image regions as object information item. A classifier may be trained in advance. Thus, the parameters of the classifier may be determined using reference data records. An image region or a region in the image data may be assigned a probability value using the classifier, said probability value representing a probability for a wheel or an axle.

A background estimation using statistical methods may occur in the editing step. Here, the statistical background in the image data may be identified using statistical methods; in the process, a probability for a static image background may be determined. Image regions adjoining a vehicle may be assigned to a road surface or lane. Here, an information item about the static image background may also be transformed into a different view, for example a side view.

The editing step may comprise a step of ascertaining contact patches on the lane using the first image data and additionally, or alternatively, the second image data and additionally, or alternatively, first image data derived therefrom and additionally, or alternatively, second image data derived therefrom in order to provide contact patches of the vehicle on the lane as object information item. If a contact patch is assigned to an axle, it may relate to a rolling axle. Here, use may be made of a 3D reconstruction of the vehicle from the image data of the stereo camera. Positions at which a vehicle, or an object, contacts the lane in the three-dimensional model or is situated within a predetermined tolerance range indicate a high probability for an axle, in particular a rolling axle.

The editing step may comprise a step of model-based identification of wheels and/or axles using the first image data and additionally, or alternatively, the second image data and additionally, or alternatively, first image data derived therefrom and additionally, or alternatively, second image data derived therefrom in order to provide identified wheel contours and/or axles of the vehicle as object information item. A three-dimensional model of a vehicle may be generated from the image data of the stereo camera. Wheel contours, and hence axles, may be determined from the three-dimensional model of the vehicle. The number of axles the vehicle has may thus be determined from the 3D reconstruction.

It is also expedient if the editing step comprises a step of projecting from the image data of the stereo camera in the image of a side view of the vehicle. Thus, certain object information items from a three-dimensional model may be used in a transformed side view for the purposes of identifying axles. By way of example, the three-dimensional model may be subjected to a step of homographic rectification.

Further, the editing step may comprise the step of determining self-similarities using the first image data and additionally, or alternatively, the second image data and additionally, or alternatively, first image data derived therefrom and additionally, or alternatively, second image data derived therefrom and additionally, or alternatively, the object information item in order to provide wheel positions of the vehicle, determined by way of self-similarities, as object information item. An image of an axle or of a wheel of a vehicle in one side view may be similar to an image of a further axle of the vehicle in a side view. Here, self-similarities may be determined using an autocorrelation. Peaks in a result of the autocorrelation function may highlight similarities of image content in the image data. A number and a spacing of the peaks may highlight an indication for axle positions.

It is also expedient if the editing step in one embodiment comprises a step of analyzing motion unsharpness using the first image data and additionally, or alternatively, the second image data and additionally, or alternatively, first image data derived therefrom and additionally, or alternatively, second image data derived therefrom and additionally, or alternatively, the object information item in order to assign depicted axles to static axles of the vehicle and additionally, or alternatively, rolling axles of the vehicle and provide this as object information item. Rolling or used axles may have a certain motion unsharpness on account of a wheel rotation. An information item about a rolling axle may be obtained from a certain motion unsharpness. Static axles may be elevated on the vehicle, and so the associated wheels are not used. Candidates for used or rolling axles may be distinguished by a motion unsharpness on account of wheel rotation. In addition to the different heights of static and moving wheels or axles in the image data, the different extents of motion unsharpness may mark features for identifying static and moving axles. The imaging sharpness for image regions in which the wheel is imaged may be estimated by summing the magnitudes of the second derivatives in the image. Wheels on moving axles may offer a less sharp image than wheels on static axles on account of the rotational movement. Furthermore, it is possible to actively control and measure the motion unsharpness. To this end, use may be made of correspondingly high exposure times. The resulting images may show straight-lined movement profiles along the direction of travel in the case of static axles and radial profiles of moving axles.

Further, an embodiment of the approach presented here, in which first image data and second image data are read in the reading step, said image data representing image data which were recorded by an image data recording sensor arranged at the side of the lane, is advantageous. Such an embodiment of the approach presented here offers the advantage of being able to undertake a very precisely operating contactless count of axles of the vehicle as incorrect identification and incorrect interpretation of objects in the edge region of the region monitored by the image data recording sensor may be largely minimized, avoided or completely suppressed on account of the defined direction of view from the side of the lane to a vehicle passing an axle-counting unit.

Further, first image data and second image data may be read in the reading step in a further embodiment of the approach presented here, said image data being recorded using a flash-lighting unit for improving the illumination of a capture region of the image data recording sensor. Such a flash-lighting unit may be an optical unit embodied to emit light, for example in the visible spectral range or in the infrared spectral range, into a region monitored by an image data recording sensor in order to obtain a sharper or brighter image of the vehicle passing this region. In this manner, it is advantageously possible to obtain an improvement in the axle identification when evaluating the first image data and second image data, as a result of which an efficiency of the method presented here may be increased.

Furthermore, an embodiment of the approach presented here in which, further, vehicle data of the vehicle passing the image data recording sensor are read in the reading step is conceivable, wherein the number of axles is determined in the determining step using the read vehicle data. By way of example, such vehicle data may be understood to mean one or more of the following parameters: speed of the vehicle relative to the image data recording sensor, distance/position of the vehicle in relation to the image data recording sensor, size/length of the vehicle, or the like. Such an embodiment of the method presented here offers the advantage of being able to realize a significant clarification and acceleration of the contactless axle count in the case of little additional outlay for ascertaining the vehicle data, which may already be provided by simple and easily available sensors.

An axle-counting apparatus for counting axles of a vehicle on a lane in a contactless manner comprises at least the following features:
an interface for reading first image data at a first instant and reading second image data at a second instant differing from the first, wherein the first image data and additionally, or alternatively, the second image data represent image data from a stereo camera arranged at the side of the lane, said image data being provided at an interface, wherein the first image data and additionally, or alternatively, the second image data comprise an image of the vehicle;
a device for editing the first image data and additionally, or alternatively, the second image data in order to obtain edited first image data and additionally, or alternatively, edited second image data, wherein at least one object is detected in the first image data and additionally, or alternatively, the second image data in a detecting device using the first image data and additionally, or alternatively, the second image data and wherein an object information item representing the object and assigned to the first image data and additionally, or alternatively, second image data is provided and wherein the at least one object is tracked in time in the image data in a tracking device using the object information item and wherein the at least one object is identified and additionally, or alternatively, classified in a classifying device using the object information item; and
a device for determining a number of axles of the vehicle and additionally, or alternatively, assigning the axles to static axles of the vehicle and rolling axles of the vehicle using the edited first image data and additionally, or alternatively, the edited second image data and additionally, or alternatively, the object information item assigned to the edited image data in order to count the axles of the vehicle in a contactless manner.

The axle-counting apparatus is embodied to carry out or implement the steps of a variant of a method presented here in the corresponding devices. The problem addressed by the invention may also be solved quickly and efficiently by this embodiment variant of the invention in the form of an apparatus. The detecting device, the tracking device and the classifying device may be partial devices of the editing device in this case.

In the present case, an axle-counting apparatus may be understood to mean an electric appliance which processes sensor signals and outputs control signals and special data signals dependent thereon. The axle-counting apparatus, also referred to simply as apparatus, may have an interface which may be embodied in terms of hardware and/or software. In the case of an embodiment in terms of hardware, the interfaces may be, for example, part of a so-called system ASIC, which contains very different functions of the apparatus. However, it is also possible for the interfaces to be dedicated integrated circuits or at least partly include discrete components. In the case of an embodiment in terms of software, the interfaces may be software modules which, for example, are present on a microcontroller in addition to other software modules.

An axle-counting system for road traffic is presented, said axle-counting system comprising at least one stereo camera and a variant of an axle-counting apparatus described here in order to count axles of a vehicle on a lane in a contactless manner. The sensor system of the axle-counting system may be arranged or assembled on a mast or in a turret next to the lane.

A computer program product with program code, which may be stored on a machine-readable medium such as a semiconductor memory, a hard disk drive memory or an optical memory and which is used to carry out the method according to one of the embodiments described above when the program product is run on a computer or an apparatus, is also advantageous.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an illustration of an axle-counting system in accordance with an exemplary embodiment of the present invention;

FIG. 2 shows a block diagram of an axle-counting apparatus for counting axles of a vehicle on a lane in a contactless manner, in accordance with one exemplary embodiment of the present invention;

FIG. 3 shows a flowchart of a method in accordance with an exemplary embodiment of the present invention;

FIG. 4 shows a flowchart of a method in accordance with an exemplary embodiment of the present invention;

FIG. 5 shows a schematic illustration of an axle-counting system in accordance with an exemplary embodiment of the present invention;

FIG. 6 shows a concept illustration of the classification in accordance with one exemplary embodiment of the present invention;

FIG. 7 to FIG. 9 show a photographic side view and illustration of identified axles in accordance with one exemplary embodiment of the present invention;

FIG. 10 shows a concept illustration of fitting primitives in accordance with one exemplary embodiment of the present invention;

FIG. 11 shows a concept illustration of identifying radial symmetries in accordance with one exemplary embodiment of the present invention;

FIG. 12 shows a concept illustration of stereo image processing in accordance with one exemplary embodiment of the present invention;

FIG. 13 shows a simplified illustration of edited image data with a characterization of objects close to the lane in accordance with one exemplary embodiment of the present invention;

FIG. 14 shows an illustration of arranging, next to a lane, an axle-counting system comprising an image recording sensor;

FIG. 15 shows an illustration of stitching, in which image segments of the vehicle recorded by an image data recording sensor were combined to form an overall image; and

FIG. 16 shows an image of a vehicle generated from an image which was generated by stitching different image segments recorded by an image data recording sensor.

### DETAILED DESCRIPTION

In the following description of expedient exemplary embodiments of the present invention, the same or similar reference signs are used for the elements which are depicted in the various figures and have a similar effect, with a repeated description of these elements being dispensed with.

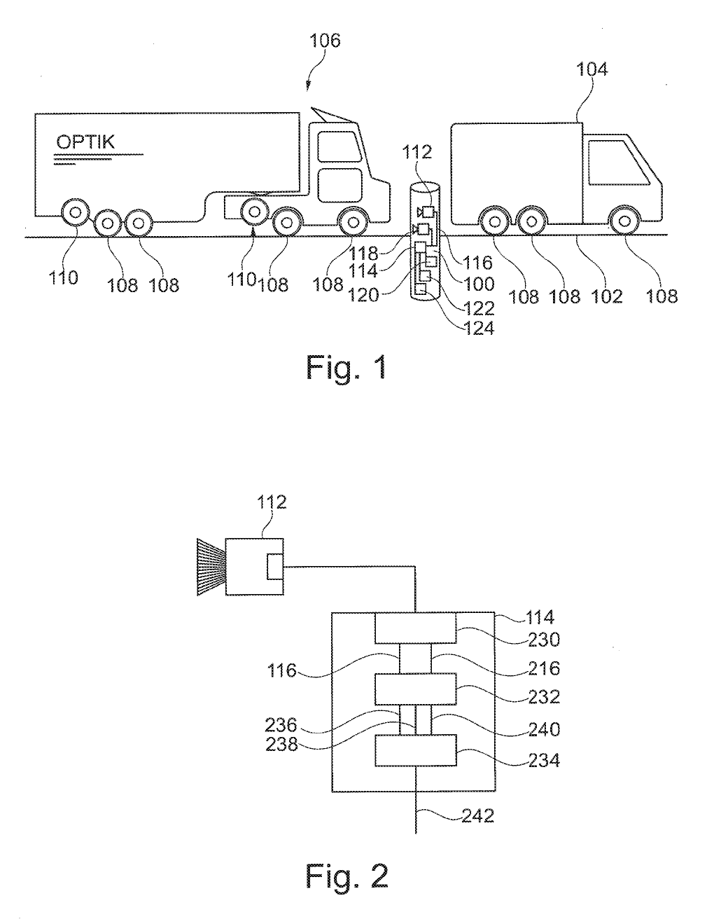

FIG. 1 shows an illustration of an axle-counting system 100 in accordance with one exemplary embodiment of the present invention. The axle-counting system 100 is arranged next to a lane 102. Two vehicles 104, 106 are depicted on the lane 102. In the shown exemplary embodiment, these are commercial vehicles 104, 106 or trucks 104, 106. In the illustration of FIG. 1, the driving direction of the two vehicles 104, 106 is from left to right. Hence, the front vehicle 104 is a box-type truck 104. The rear vehicle 106 is a semitrailer tractor with a semitrailer.

The vehicle 104, i.e. the box-type truck, comprises three axles 108. The three axles 108 are rolling or loaded axles 108. The vehicle 106, i.e. the semitrailer tractor with semitrailer, comprises a total of six axles 108, 110. Here, the semitrailer tractor comprises three axles 108, 110 and the semitrailer comprises three axles 108, 110. Of the three axles 108, 110 of the semitrailer tractor and the three axles 108, 110 of the semitrailer, two axles 108 are in contact with the lane in each case and one axle 110 is arranged above the lane in each case. Thus, the axles 108 are rolling or loaded axles 108 in each case and the axles 110 are static or unloaded axles 110.

The axle-counting system 100 comprises at least one image data recording sensor and an axle-counting apparatus 114 for counting axles of a vehicle 104, 106 on the lane 102 in a contactless manner. In the exemplary embodiment shown in FIG. 1, the image data recording sensor is embodied as a stereo camera 112. The stereo camera 112 is embodied to capture an image in the viewing direction in front of the stereo camera 112 and provide this as image data 116 at an interface. The axle-counting apparatus 114 is embodied to receive and evaluate the image data 116 provided by the stereo camera 112 in order to determine the number of axles 108, 110 of the vehicles 104, 106. In a particularly expedient exemplary embodiment, the axle-counting apparatus 114 is embodied to distinguish the axles 108, 110 of a vehicle 104, 106 according to rolling axles 108 and static axles 110. The number of axles 108, 110 is determined on the basis of the number of observed wheels.

Optionally, the axle-counting system 100 comprises at least one further sensor system 118, as depicted in FIG. 1. Depending on the exemplary embodiment, the further sensor system 118 is a further stereo camera 118, a mono camera 118 or a radar sensor system 118. In optional extensions and exemplary embodiments not depicted here, the axle-counting system 100 may comprise a multiplicity of the same or mutually different sensor systems 118. In an exemplary embodiment not shown here, the image data recording sensor is a mono camera, as depicted here as further sensor system 118 in FIG. 1. Thus, the image data recording sensor may be embodied as a stereo camera 112 or as a mono camera 118 in variants of the depicted exemplary embodiment.

In a variant of the axle-counting system 100 described here, the axle-counting system 100 furthermore comprises a device 120 for temporary storage of data and a device 122 for long-distance transmission of data. Optionally, the system 100 furthermore comprises an uninterruptible power supply 124.

In contrast to the exemplary embodiment depicted here, the axle-counting system 100 is assembled in a column or on a mast on a traffic-control or sign gantry above the lane 102 or laterally above the lane 102 in an exemplary embodiment not depicted here.

An exemplary embodiment as described here may be employed in conjunction with a system for detecting a toll requirement for using traffic routes. Advantageously, a vehicle 104, 106 may be determined with low latency while the vehicle 104, 106 passes over an installation location of the axle-counting system 100.

A mast installation of the axle-counting system 100 comprises components for data capture and data processing, for at least temporary storage and long-distance transmission of data and for an uninterruptible power supply in one exemplary embodiment, as depicted in FIG. 1. A calibrated or self-calibrating stereo camera 112 may be used as a sensor system. Optionally, use is made of a radar sensor 118. Furthermore, the use of a mono camera with a further depth-measuring sensor is possible.

FIG. 2 shows a block diagram of an axle-counting apparatus 114 for counting axles of a vehicle on a lane in a contactless manner in accordance with one exemplary embodiment of the present invention. The axle-counting apparatus 114 may be the axle-counting apparatus 114 shown in FIG. 1. Thus, the vehicle may likewise be an exemplary embodiment of a vehicle 104, 106 shown in FIG. 1. The axle-counting apparatus 114 comprises at least one reading interface 230, an editing device 232 and determining device 234.

The reading interface 230 is embodied to read at least first image data 116 at a first instant t1 and second image data 216 at a second instant t2. Here, the first instant t1 and the second instant t2 are two mutually different instants t1, t2. The image data 116, 216 represent image data provided at an interface of a stereo camera 112, said image data comprising an image of a vehicle on a lane. Here, at least one image of a portion of the vehicle is depicted or represented in the image data. As described below, at least two images or items of image data 116, which each image a portion of the vehicle, may be combined to form further image data 116 in order to obtain a complete image from a viewing direction of the vehicle.

The editing device 232 is embodied to provide edited first image data 236 and edited second image data 238 using the first image data 116 and the second image data 216. To this end, the editing device 232 comprises at least a detecting device, a tracking device and a classifying device. In the detecting device, at least one object is detected in the first image data 116 and the second image data 216 and provided as an object information item 240 representing the object, assigned to the respective image data. Here, depending on the exemplary embodiment, the object information item 240 comprises e.g. a size, a location or a position of the identified object. The tracking device is embodied to track the at least one object through time in the image data 116, 216 using the object information item 240. The tracking device is furthermore embodied to predict a position or location of the object at a future time. The classifying device is embodied to identify the at least one object using the object information item 240, i.e., for example, to distinguish the vehicles according to vehicles with a box-type design and semitrailer tractors with a semitrailer. Here, the number of possible vehicle classes may be selected virtually arbitrarily. The determining device 234 is embodied to determine a number of axles of the imaged vehicle or an assignment of the axles to static axles and rolling axles using the edited first image data 236, the edited second image data 238 and the object information items 240 assigned to the image data 236, 238. Furthermore, the determining device 234 is embodied to provide a result 242 at an interface.

In one exemplary embodiment, the apparatus 114 is embodied to create a three-dimensional reconstruction of the vehicle and provide this for further processing.

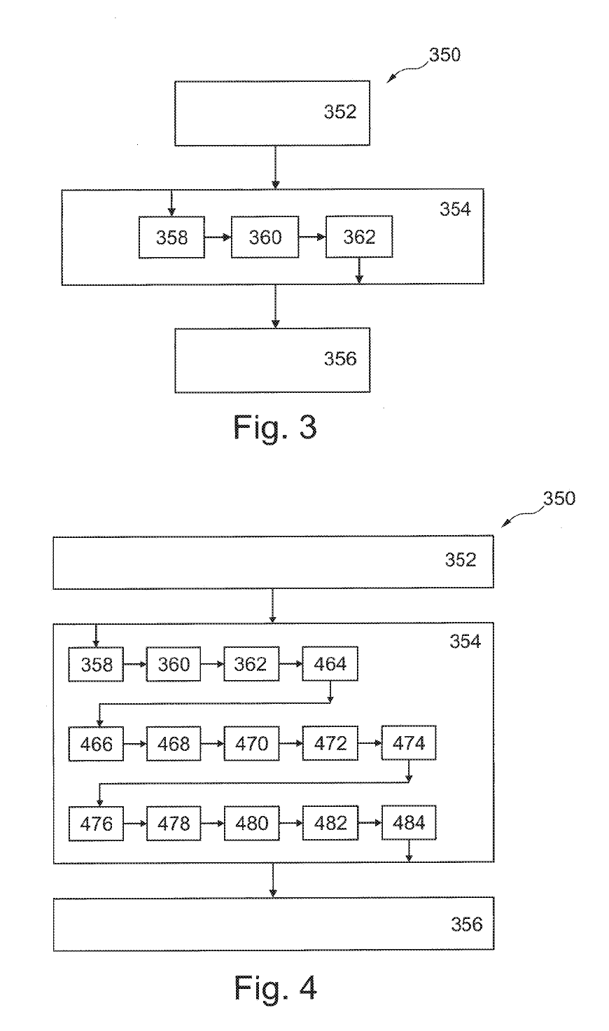

FIG. 3 shows a flowchart of a method 350 in accordance with one exemplary embodiment of the present invention. The method 350 for counting axles of a vehicle on a lane in a contactless manner comprises three steps: a reading step 352, an editing step 354 and a determining step 356. First image data are read at the first instant and second image data are read at the second instant in the reading step 352. The first image data and the second image data are read in parallel in an alternative exemplary embodiment. Here, the first image data represent image data captured by a stereo camera at a first instant and the second image data represent image data captured at a second instant which differs from the first instant. Here, the image data comprises at least one information item about an image of a vehicle on a lane. At least one portion of the vehicle is imaged in one exemplary embodiment. Edited first image data, edited second image data and object information items assigned to the image data are edited in the editing step 354 using the first image data and the second image data. A number of axles of the vehicle is determined in the determining step 356 using the edited first image data, the edited second image data and the object information item assigned to the edited image data. In an expedient exemplary embodiment, the axles of the vehicle are distinguished according to static axles and rolling axles or the overall number is assigned thereto in the determining step 356 in addition to the overall number of the axles of the vehicle.

The editing step 354 comprises at least three partial steps 358, 360, 362. At least one object is detected in the first image data and the second image data and an object information item representing the object in a manner assigned to the first image data and the second image data is provided in the detection partial step 358. The at least one object detected in partial step 358 is tracked over time in the image data in the tracking partial step 360 using the object information item. The at least one object is classified using the object information item in the classifying partial step 362 following the tracking partial step 360.

FIG. 4 shows a flowchart of the method 350 in accordance with one exemplary embodiment of the present invention. The method 350 for counting axles of a vehicle on a lane in a contactless manner may be an exemplary embodiment of the method 350 for counting axles of a vehicle on a road in a contactless manner shown in FIG. 3. The method comprises at least a reading step 352, an editing step 354 and a determining step 356.

The editing step 354 comprises at least the detection partial step 358, the tracking partial step 360 and the classifying partial step 362 described in FIG. 3. Optionally, the method 350 comprises further partial steps in the editing step 354. The optional partial steps of the editing step 354, described below, may both be modified in terms of the sequence thereof in exemplary embodiments and be carried out as only some of the optional steps in exemplary embodiments not shown here.

The axle counting and differentiation according to static and rolling axes is advantageously carried out in optional exemplary embodiments by a selection and combination of the following steps. Here, the optional partial steps provide a result as a complement to the object information item and additionally, or alternatively, as edited image data. Hence, the object information item may be expanded by each partial step. In one exemplary embodiment, the object information item after running through the method steps comprises an information item about the vehicle, comprising the number of axles and an assignment to static axles and rolling axles. Thus, a number of axles and, optionally and in a complementary manner, an assignment of the axles to rolling axles and static axles using the object information item may be determined in the determining step 356.

There is a homographic rectification of the side view of a vehicle in optional partial step 464 of homographic rectification in the editing step 354. Here, the trajectory of the cuboid circumscribing the vehicle or the cuboid circumscribing the object detected as a vehicle is ascertained from the 3D reconstruction over time profile of the vehicle movement. Hence, the rotational position of the vehicle in relation to the measuring appliance and the direction of travel is known at all times after an initialization. If the rotational position is known, it is possible to generate a view as would arise in the case of an orthogonal view of the side of the vehicle by calculating a homography, with this statement being restricted to a planar region. As a result, wheel contours are depicted in a virtually circular manner and the used wheels are situated at the same height in the transformed image. Here, edited image data may be understood to mean a transformed image.

Optionally, the editing step 354 comprises an optional partial step 466 of stitching image recordings in the near region. The local image resolution drops with increasing distance from the measurement system and hence from the cameras such as e.g. the stereo camera. For the purposes of a virtually constant resolution of a vehicle such as e.g. a long tractor unit, a plurality of image recordings, in which various portions of a long vehicle are close to the camera in each case, are combined. The combination of the overlapping partial images may be initialized well by the known speed of the vehicle. Subsequently, the result of the combination is optimized using local image comparisons in the overlap region. At the end, edited image data or an image recording of a side view of the vehicle with a virtually constant and high image resolution are/is available.

In an optional exemplary embodiment, the editing step 354 comprises a step 468 of fitting primitives in the original image and in the rectified image. Here, the original image may be understood to mean the image data and the rectified image may be understood to mean the edited image data. Fitting of the geometric primitives is used as an option for identifying wheels in the image or in the image data. In particular, circles and ellipses, and segments of circles and ellipses should be understood to be primitives in this exemplary embodiment. Conventional estimation methods supply quality measures for fitting a primitive to a wheel contour. The wheel fitting in the transformed side view may be backed by fitting ellipses at the corresponding point in the original image. Candidates for the respectively associated center points emerge by fitting segments. An accumulation of such center-point estimates indicates an increased probability of a wheel center point and hence of an axle.

Optionally, the editing step 354 comprises an optional partial step 470 of detecting radial symmetries. Wheels are distinguished by radially symmetrical patterns in the image, i.e. the image data. These patterns may be identified by means of accumulation methods. To this end, transformations into polar coordinates are carried out for candidates of centers of symmetry. Translational symmetries emerge in the polar representation; these may be identified by means of displacement detection. As result, evaluated candidates for center points of radial symmetries arise, said candidates in turn indicating wheels.

In an optional exemplary embodiment, the editing step 354 comprises a step 472 of classifying image regions. Furthermore, classification methods are used for identifying wheel regions in the image. To this end, a classifier is trained in advance, i.e. the parameters of the classifier are calculated using annotated reference data records. In the application, an image region, i.e. a portion of the image data, is provided with a value by the classifier, said value describing the probability that this is a wheel region. The preselection of such an image region may be carried out using the other methods presented here.

Optionally, the editing step 354 comprises an optional partial step 474 of estimating the background using a camera. What is used here is that static background in the image may be identified using statistical methods. A distribution may be established by accumulating processed local grayscale values, said distribution correlating with the probability of static image background. When a vehicle passes through, image regions adjoining the vehicle may be assigned to the road surface. These background points may also be transformed into a different view, for example the side view. Hence, an option is provided for delimiting the contours of the wheels against the background. A characteristic recognition feature is provided by the round edge profile.

In one exemplary embodiment, the editing step 354 comprises an optional step 476 of ascertaining contact patches on the road surface in the image data of the stereo camera or in a 3D reconstruction using the image data. The 3D reconstruction of the stereo system may be used to identify candidates for wheel positions. Positions in the 3D space may be determined from the 3D estimate of the road surface in combination with the 3D object model, said positions coming very close, or touching, the road surface. The presence of a wheel is likely at these points; candidates for the further evaluation emerge.

The editing step 354 optionally comprises a partial step 478 of the model-based recognition of the wheels from the 3D object data of a vehicle. Here, the 3D object data may be understood to mean the object information item. A qualitatively high-quality 3D model of a vehicle may be generated by bundle adjustment or other methods of 3D optimization. Hence, the model-based 3D recognition of the wheel contours is possible.

In an optional exemplary embodiment, the editing step 354 comprises a step 480 of projecting from the 3D measurement to the image of the side view. Here, information items ascertained from the 3D model are used in the transformed side view, for example for identifying static axles. To this end, 3D information items are subjected to the same homography of the side view. Preprocessing in this respect sees the 3D object being projected into the plane of the vehicle side. The distance of the 3D object from the side plane is known. In the transformed view, the projection of the 3D object may then be seen in the view of the vehicle side.

Optionally, the editing step 354 comprises an optional partial step 482 of checking for self-similarities. Wheel regions of a vehicle usually look very similar in a side view. This circumstance may be used by virtue of self-similarities of a specific image region of the side view being checked by means of an autocorrelation. A peak or a plurality of peaks in the result of the autocorrelation function show displacements of the image which lead to a greatest possible similarity in the image contents. Deductions may be drawn about possible wheel positions from the number of and distances between the peaks.

In one exemplary embodiment, the editing step 354 comprises an optional step 484 of analyzing a motion unsharpness for identifying static and moring axles. Static axles are elevated on the vehicle, and so the associated wheels are not in use. Candidates for used axles are distinguished by motion unsharpness on account of a wheel rotation. In addition to the different elevations of static and moving wheels in the image, the different motion unsharpnesses mark features for identifying static and moving or rolling or loaded axles. The image sharpness is estimated for image regions in which a wheel is imaged by summing the magnitudes of the second derivatives in the image. Wheels on moving axles offer a less sharp image than wheels on static axles as a result of the rotational movement. As a result, a first estimate in respect of which axles are static or moving arises. Further information items for the differentiation may be taken from the 3D model.

As a further approach, the motion unsharpness is optionally controlled and measured actively. To this end, correspondingly high exposure times are used. The resulting images show straight-lined movement profiles along the driving direction in the case of static axles and radial profiles on moving axles.

In a special exemplary embodiment, a plurality of method steps perform the configuration of the system and the evaluation of the moving traffic in respect of the problem. If use is made of an optional radar sensor, individual method steps are optimized by means of data fusion at different levels in a fusing step (not depicted here). In particular, the dependencies in relation to the visual conditions are reduced by means of a radar sensor. The influence of disadvantageous weather and darkness on the capture rate is reduced. As already described in FIG. 3, the editing step 354 comprises at least three partial steps 358, 360, 362. Objects are detected, i.e. objects on the road in the monitored region are captured, in the detecting step 358. Here, data fusion with radar is advantageous. Objects are tracked in the tracking step 360, i.e. moving objects are tracked over time. An extension or combination with an optional fusing step for the purpose of data fusion with radar is advantageous in the tracking step 360. Objects are classified or candidates for trucks are identified in the classifying partial steps 362. A data fusion with radar is advantageous in classifying partial step 362.

In an optional exemplary embodiment, the method comprises a calibrating step (not shown here) and a step of configuring the traffic scene (not shown here). Optionally, there is a self-calibration or a transfer of the sensor system into a state ready for measuring in the calibrating step. An alignment of the sensor system in relation to the road is known as a result of the optional step of configuring the traffic scene.

Advantageously, the described method 350 uses 3D information items and image information items, wherein a corresponding apparatus, as shown in e.g. FIG. 1, is installable on a single mast. A use of a stereo camera and, optionally, a radar sensor system in a complementary manner develops a robust system with a robust, cost-effective sensor system and without moving parts. Advantageously, the method 350 has a robust identification capability, wherein a corresponding apparatus, as shown in FIG. 1 or FIG. 2, has a system capability for self-calibration and self-configuration.

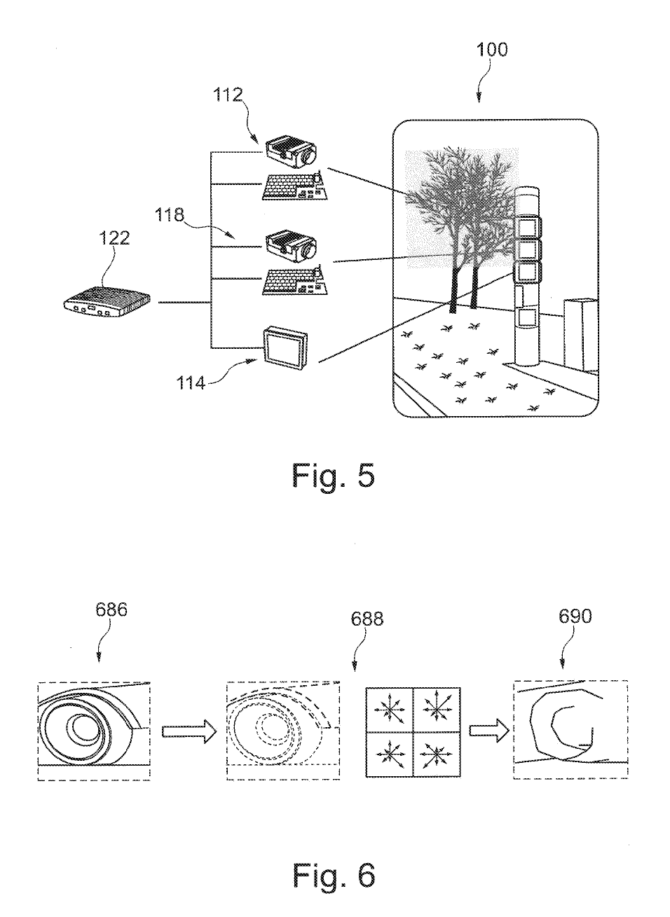

FIG. 5 shows a schematic illustration of an axle-counting system 100 in accordance with one exemplary embodiment of the present invention. The axle-counting system 100 is installed in a column. Here, the axle-counting system 100 may be an exemplary embodiment of an axle-counting system 100 shown in FIG. 1. In the exemplary embodiment shown in FIG. 5, the axle-counting system 100 comprises two cameras 112, 118, one axle-counting apparatus 114 and a device 122 for long-distance transmission of data. The two cameras 112, 118 and the axle-counting apparatus 114 are additionally depicted separately next to the axle-counting system 100. The cameras 112, 118, the axle-counting apparatus 114 and the device 122 for long-distance transmission of data are coupled to one another by way of a bus system. By way of example, the aforementioned devices of the axle-counting system 100 are coupled to one another by way of an Ethernet bus. Both the stereo camera 112 and the further sensor system 118 which represent a stereo camera 118 or a mono camera 118 or radar sensor system 118, are depicted in the exemplary embodiment shown in FIG. 5 as a sensor system 112, 118 with a displaced sensor head or camera head. The circuit board assigned to the sensor head or camera head comprises apparatuses for preprocessing the captured sensor data and for providing the image data. In one exemplary embodiment, coupling between the sensor head and the assigned circuit board is brought about by way of the already mentioned Ethernet bus and, in another exemplary embodiment not depicted here, by way of a proprietary sensor bus such as e.g. Camera-Link, FireWire IEEE-1394 or GigE (Gigabit-Ethernet) with Power-over-Ethernet (PoE). In a further exemplary embodiment not shown here, the circuit board assigned to the sensor head, the device 122 for long-distance transmission of data and the axle-counting apparatus 114 are coupled to one another by way of a standardized bus such as e.g. PCI or PCIe. Naturally, any combination of the aforementioned technologies is expedient and possible.

In a further exemplary embodiment not shown here, the axle-counting system 100 comprises more than two sensor systems 112, 118. By way of example, the use of two independent stereo cameras 112 and a radar sensor system 118 is conceivable. Alternatively, an axle-counting system 100 not depicted here comprises a stereo camera 112, a mono camera 118 and a radar sensor system 118.

FIG. 6 shows a concept illustration of a classification in accordance with one exemplary embodiment of the present invention. By way of example, such a classification may be used in the classification step 472 as partial step of editing step 354 in the method 350, described in FIG. 4, in one exemplary embodiment. In the exemplary embodiment shown in FIG. 6, use is made of an HOG-based detector. Here, the abbreviation HOG stands for “histograms of oriented gradients” and denotes a method for obtaining features in image processing. The classification develops autonomous learning of the object properties (template) on the basis of provided training data; here, it is substantially sets of object edges with different positions, lengths and orientations that are learnt. Here, object properties are trained over a number of days in one exemplary embodiment. The classification shown here develops real-time processing by way of a cascade approach and pixel-accurate query mechanism, for example a query generation by stereo preprocessing.

The classification step 472 described in detail in FIG. 6 comprises a first partial step 686 of generating a training data record. In the exemplary embodiment, the training data record is generated using several 1000 images. In a second partial step 688 of calculations, the HOG features are calculated from gradients and statistics. In a third partial step 690 of learning, the object properties and a universal textual representation are learnt.

By way of example, such a textual representation may be represented as follows:

```
        <weakClassifiers>
        <_>
        <internalNodes>
                0 −1 29 5.1918663084506989e⁻¹
        <leafValues>
−  9.6984922885894775e^{-0.01} 9.6
        <_>
        <internalNodes>
                0 − 1 31 1.4692706510160446e⁻¹
        <leafValues>
```

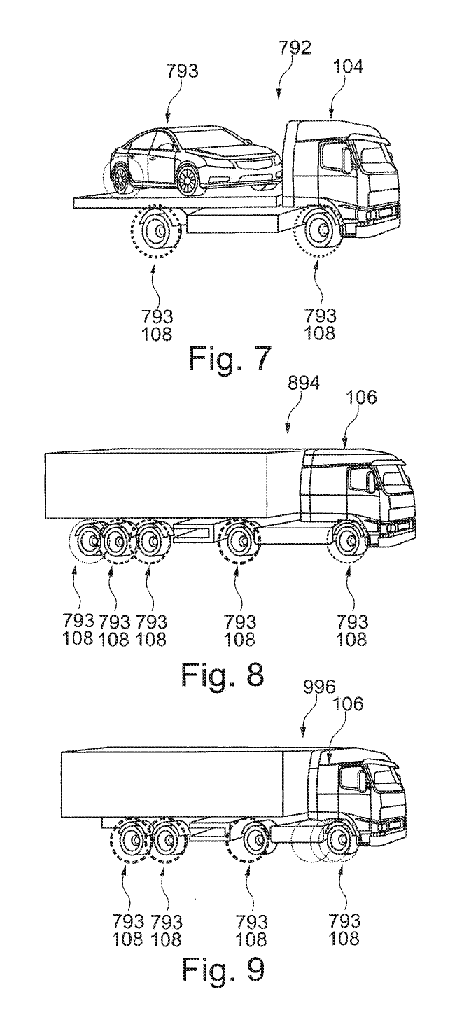

FIG. 7 to FIG. 9a show photographic side view 792, 894, 996 and an illustration of identified axles 793 in accordance with one exemplary embodiment of the present invention. The identified axles 793 may be rolling axles 108 and static axles 110 of an exemplary embodiment shown in FIG. 1. The axles may be identified using the axle-counting system 100 shown in FIG. 1 and FIG. 2. One vehicle 104, 106 is depicted in each case in the photographic side views 792, 894, 996.

FIG. 7 shows a tow truck 104 with a further vehicle on the loading area in a side view 792 in accordance with one exemplary embodiment of the present invention. If the axle-counting system is used to capture and calculate tolls for the use of traffic routes, only the rolling or static axles of the tow truck 104 are relevant. In the photographic side view 792 shown in FIG. 7, at least one axle 793 of the vehicle situated on the loading area of the vehicle 104 is identified in addition to two (rolling) axles 108, 793 of the tow truck 104, and marked accordingly for an observer of the photographic side view 792.

FIG. 8 shows a vehicle 106 in a side view 894 in accordance with one exemplary embodiment of the present invention. In the illustration, the vehicle 106 is a semitrailer truck with a semitrailer, similar to the exemplary embodiment shown in FIG. 1. The semitrailer tractor or the semitrailer truck has two axles; the semitrailer has three axles. A total of five axles 793 are identified and marked in the side view 894. Here, the two axles of the semitrailer truck and the first two axles of the semitrailer following the semitrailer truck are rolling axles 108; the third axle of the semitrailer truck is a static axle 110.

FIG. 9 shows a vehicle 106 in a side view 996 in accordance with one exemplary embodiment of the present invention. Like in the illustration in FIG. 8, the vehicle 106 is a semitrailer truck with a semitrailer. The vehicle 106 depicted in FIG. 9 has a total of four axles 108, which are marked in the illustration as identified axles 793. The four axles 108 are rolling axles 108.

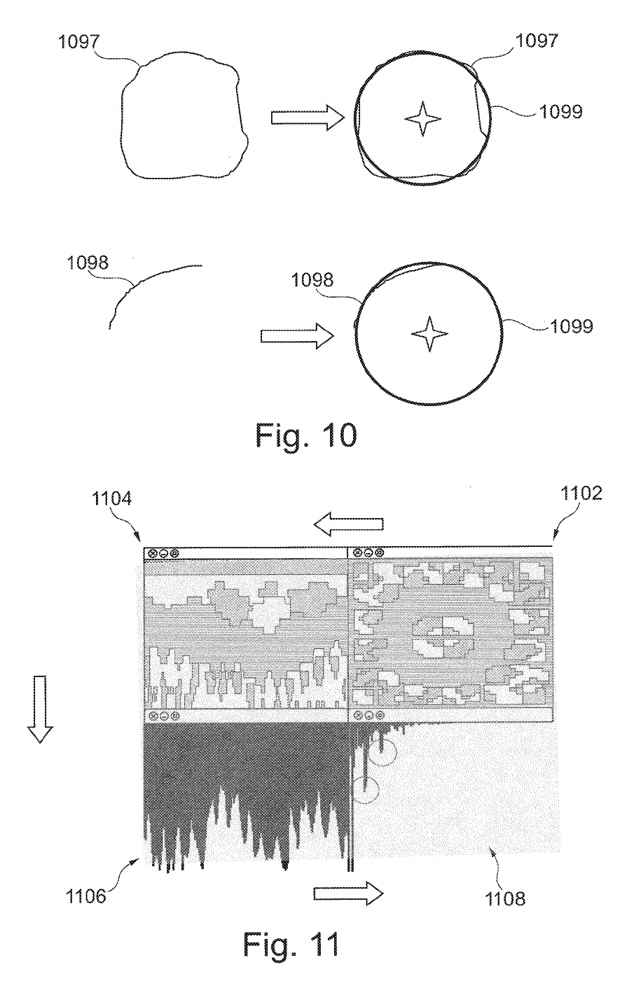

FIG. 10 shows a concept illustration of fitting primitives in accordance with one exemplary embodiment of the present invention. By way of example, such fitting of primitives may be used in one exemplary embodiment in the step 468 of fitting primitives, described in FIG. 4, as a partial step of the editing step 354 of the method 350. The step 468 of fitting primitives, described in FIG. 4, comprises three partial steps in an exemplary embodiment depicted in FIG. 10, wherein an extraction of relevant contours 1097, 1098 by means of a band-pass filter and an edge detection takes place in a first partial step, a pre-filtering of contours 1097, 1098 is carried out in a second partial step and a fitting of ellipses 1099 or circles 1099 to filtered contours 1097, 1098 is carried out in a third partial step. Here, fitting may be understood to mean adapting or adjusting. A primitive 1099 may be understood to mean a geometric (base) form. Thus, in the exemplary embodiment depicted in FIG. 10, a primitive 1099 is understood to mean a circle 1099; a primitive 1099 is understood to mean an ellipse 1099 in an alternative exemplary embodiment not depicted here. In general, a primitive may be understood to mean a planar geometric object. Advantageously, objects may be compared to primitives stored in a pool. Thus, the pool with the primitives may be developed in a learning partial step.

FIG. 10 depicts a first closed contour 1097, into which a circle 1099 is fitted as a primitive 1099. Below, a contour of a circle segment 1098, which follows a portion of the primitive 1099 in the form of a circle 1099, is shown. In an expedient exemplary embodiment, a corresponding segment 1098 is identified and identified as part of a wheel or axle by fitting into the primitive.

FIG. 11 shows a concept illustration of identifying radial symmetries in accordance with one exemplary embodiment of the present invention. By way of example, such an identification of radial symmetries may be used in one exemplary embodiment in the step 470 of identifying radial symmetries, described in FIG. 4, as a partial step of the editing step 354 in the method 350. As already described in FIG. 4, wheels, and hence axles, of a vehicle are distinguished as radially symmetric patterns in the image data. FIG. 11 shows four images 1102, 1104, 1106, 1108. A first image 1102, arranged top right in FIG. 11, shows a portion of an image or of image data with a wheel imaged therein. Such a portion is also referred to as “region of interest”, ROI. The region selected in image 1102 represents a greatly magnified region or portion of image data or edited image data. The representations 1102, 1104, 1106, 1108 or images 1102, 1104, 1106, 1108 are arranged in a counterclockwise manner. The second image 1104, top left in FIG. 11, depicts the image region selected in the first image, transformed into polar coordinates. The third image 1106, bottom left in FIG. 11, shows a histogram of the polar representation 1104 after applying a Sobel operator. Here, a first derivative of the pixel brightness values is determined, with smoothing being carried out simultaneously orthogonal to the direction of the derivative. The fourth image 1108, bottom right in FIG. 11, depicts a frequency analysis. Thus, the four images 1102, 1104, 1106, 1108 show four partial steps or partial aspects, which are carried out in succession for the purposes of identifying radial symmetries: local surroundings in image 1102, a polar image in image 1104, a histogram in image 1106 and, finally, a frequency analysis in image 1108.

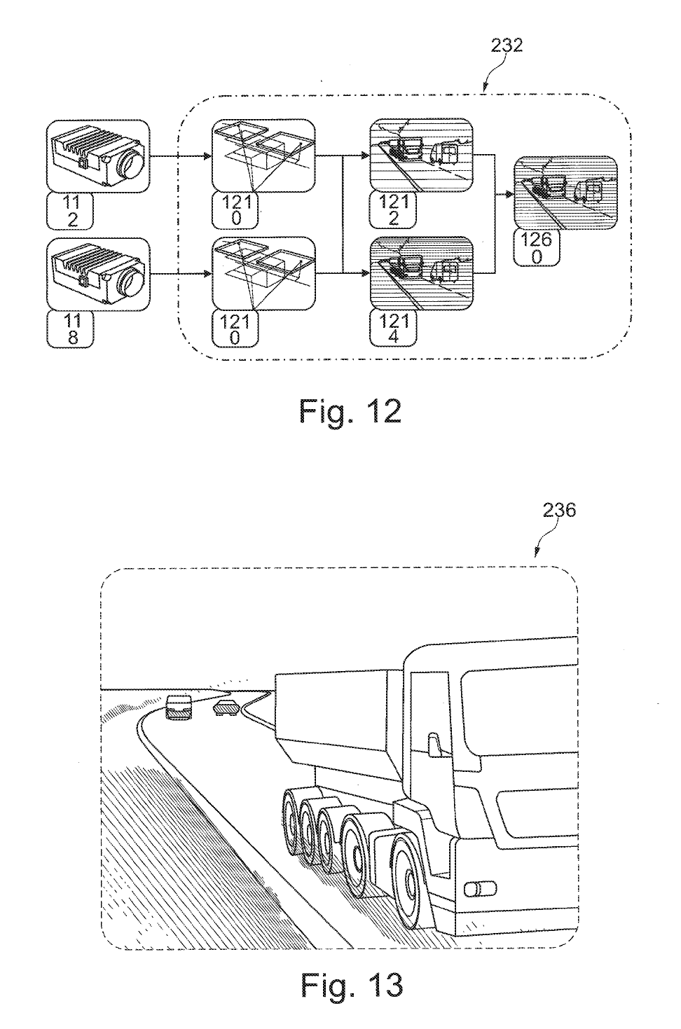

FIG. 12 shows a concept illustration of stereo image processing in accordance with one exemplary embodiment of the present invention. The stereo image processing comprises a first stereo camera 112 and a second stereo camera 118. The image data from the stereo cameras are guided to an editing device 232 by way of an interface not depicted in any more detail. The editing device may be an exemplary embodiment of the editing device 232 shown in FIG. 2. In the exemplary embodiment depicted here, the editing device 232 comprises one rectifying device 1210 for each connected stereo camera 112, 118. Geometric distortions in the image data are eliminated and the latter are provided as edited image data in the rectifying device 1210. Within this meaning, the rectifying device 1210 develops a specific form of geo-referencing of image data. The image data edited by the rectifying device 1210 are transmitted to an optical flow device 1212. In this case, the optical flow of the image data, of a sequence of image data or of an image sequence may be understood to mean the vector field of the speeds, projected into the image plane, of visible points of the object space in the reference system of the imaging optical unit. Furthermore, the image data edited by the rectifying device 1110 are transferred to a disparity device 1214. The transverse disparity is a displacement or offset in the position which the same object assumes in the image on two different image planes. The device 1214 for ascertaining the disparity is embodied to ascertain a distance to an imaged object in the image data. Consequently, the edited image data are synonymous to a depth image. Both the edited image data of the device 1214 for ascertaining the disparity and the edited image data of the device 1212 are transferred to a device 1260 for tracking and classifying. The device 1112 is embodied to track and classify a vehicle imaged in the image data over a plurality of image data sets.

FIG. 13 shows a simplified illustration of edited image data 236 with a characterization of objects close to the lane in accordance with one exemplary embodiment of the present invention. The illustration in FIG. 13 shows a 3D point cloud of disparities. A corresponding representation of the image data depicted in FIG. 13 on an indication appliance with a color display (color monitor) shows, as color coding, a height to the depicted object above a lane. For the application depicted here, a color coding of objects up to a height of 50 cm above the lane is expedient and depicted here.

Capturing specific vehicle features, such as e.g. length, number of axles (including elevated axles), body parts, subdivision into components (tractors, trailers, etc.), is a challenging problem for sensors (radar, laser, camera, etc.). In principle, this problem cannot be solved, or only solved to limited extent, using conventional systems such as radar, laser or loop installations. The use of frontal cameras or cameras facing the vehicles at a slight angle (0°-25° twist between sensor axis and direction of travel) only permits a limited capture of the vehicle properties. In this case, a high resolution, a high computational power and an exact geometric model of the vehicle are necessary for capturing the properties. Currently employed sensor systems only capture a limited part of the data required for a classification in each case. Thus, invasive installations (loops) may be used to determine lengths, speed and number of put-down axles. Radar, laser and stereo systems render it possible to capture the height, width and/or length.

Previous sensor systems can often only satisfy these objects to a limited extent. Previous sensor systems are not able to capture both put-down axles and elevated axles. Furthermore, no sufficiently good separation according to tractors and trailers is possible. Likewise, distinguishing between buses and trucks with windshields is difficult using conventional means.

The solution proposed here facilitates the generation of a high-quality side view of a vehicle, from which features such as number of axles, axles state (elevated, put it down), tractor-trailer separation, height and length estimates may be ascertained. The proposed solution is cost-effective and makes do with little computational power/energy consumption.

The approach presented here should further facilitate the facilitation of a high-quality capture of put-down and elevated vehicle axles using little computational power and low sensor costs. Furthermore, the approach presented here should offer the option of capturing tractors and trailers independently of one another, and of supplying an accurate estimate of the vehicle length and vehicle height.

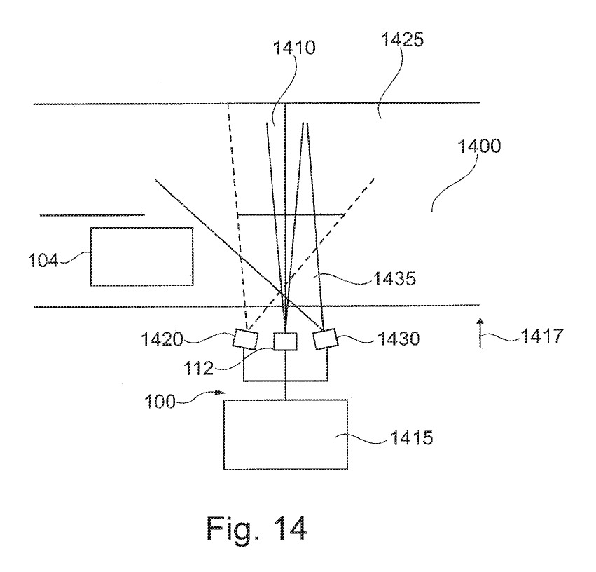

FIG. 14 shows an illustration of an arrangement of an axle-counting system 100 comprising an image data recording sensor 112 (also referred to as camera) next to a lane 1400. A vehicle 104, the axles of which are intended to be counted, travels along the lane 1400. When the vehicle travels through the monitoring region 1410 monitored by the image recording sensor 112, an image of the side of the vehicle 104 is recorded in the process in the transverse direction 1417 in relation to the lane 1400 and said image is transferred to a computing unit or to the image evaluation unit 1415, in which an algorithm for identifying or capturing a position and/or number of axles of the vehicle 104 from the image of the image data recording sensor 112 is carried out. In order to be able to illuminate the monitoring region 1410 as ideally as possible, even in the case of disadvantageous light conditions, provision is made further for a flash-lighting unit 1420 which, for example, emits an (infrared) light flash in a flash region 1425 which intersects with a majority of the monitoring region 1410. Furthermore, it is also conceivable for a supporting sensor system 1430 to be provided, said sensor system being embodied to ensure a reliable identification of the axles of the vehicle 104 traveling past the image recording sensor 112. By way of example, such a supporting sensor system may comprise a radar, lidar and/or ultrasonic sensor (not depicted in FIG. 14) which is embodied to ascertain a distance of the vehicle traveling past the image recording unit 112 within a sensor system region 1435 and use this distance for identifying lanes on which the vehicle 104 travels. By way of example, this may then also ensure that only the axles of those vehicles 104 which travel past the axle-counting system 100 within a specific distance interval are counted such that the error susceptibility of such an axle-counting system 100 may be reduced. Here, an actuation of the flash-lighting unit 1420 and the processing of data from the supporting sensor system 1430 may likewise take place in the image evaluation unit 1415.

Therefore, the proposed solution optionally contains a flash 1420 in order to generate high-quality side images, even in the case of low lighting conditions. An advantage of the small lateral distance is a low power consumption of the illumination realized thus. The proposed solution may be supported by a further sensor system 1430 (radar, lidar, laser) in order to unburden the image processing in respect of the detection of vehicles and the calculation of the optical flow (reduction in the computational power).

It is likewise conceivable that sensor systems disposed upstream or downstream thereof relay the information about the speed and the location to the side camera so that the side camera may derive better estimates for the stitching offset.

Therefore, a further component of the proposed solution is a camera 112, which is installed with an angle of approximately 90° at a small to mid lateral distance (2-5 m) and at a low height (0-3 m) in relation to the traffic, as this for example. A lens with which the relevant features of the vehicle 104 may be captured (sufficiently short focal length, i.e.: large aperture angle) is selected. In order to generate a high-quality lateral recording of the vehicle 104, the camera 112 is operated at a high frequency of several 100 Hz. In the process, a camera ROI which has a width of a few (e.g. 1-100) pixels is set. As a result, perspective distortions and optics-based distortion (in the image horizontal) are very small.

An optical flow between the individually generated slices (images) is determined by way of an image analysis (which, for example, is carried out in the image evaluation unit 1415). Then, the slices may be combined to form an individual image by means of stitching.

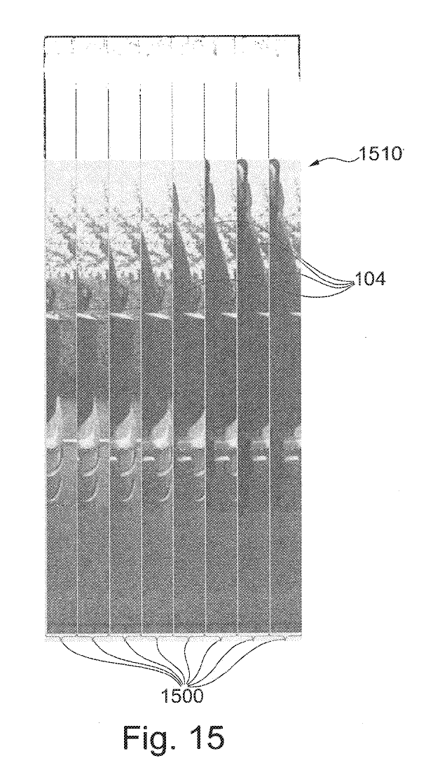

FIG. 15 shows an illustration of such a stitching, in which image segments 1500 of the vehicle 104, which were recorded at different instants during the journey past the image data recording sensor 112, are combined to form an overall image 1510.

If the image segments 1500 shown in FIG. 15 are combined to such an overall image and if the time offset of the image segments is also taken into account (for example by way of the speed of the vehicle 104 when traveling past the axle-counting system 100 determined by means of a radar sensor in the supporting sensor system 1430), then a very exact and precise image 1500 of the side view of the vehicle 104 may be undertaken from combining the slices, from which the number/position of the axles of the vehicle 104 then may be ascertained very easily in the image evaluation unit 1415.

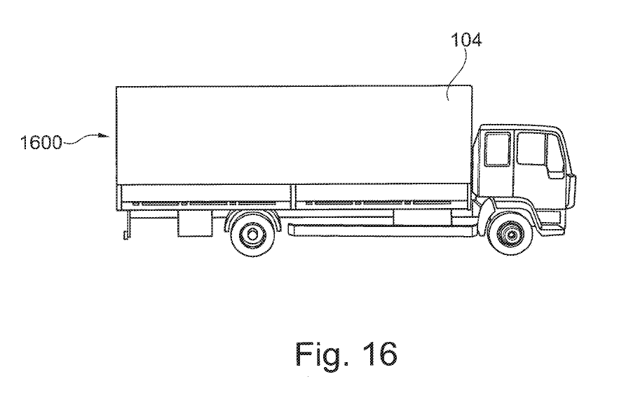

FIG. 16 shows such an image 1600 of the vehicle which was combined or smoothed from different slices of the images 1500 recorded by the image data recording sensor 112 (with a 2 m lateral distance from the lane at a 1.5 m installation height).

Therefore, the approach presented here proposes an axle-counting system 100 comprising a camera system filming the road space 1410 approximately across the direction of travel and recording image strips (slices) at a high image frequency, which are subsequently combined (stitching) to form an overall image 1500 or 1600 in order to extract subsequent information such as length, vehicle class and number of axles of the vehicle 104 on the basis thereof.

This axle-counting system 100 may be equipped with an additional sensor system 1430 which supplies a priori information about how far the object or the vehicle 104 is away from the camera 112 in the transverse direction 1417.

The system 100 may further be equipped with an additional sensor system 1430 which supplies a priori information about how quickly the object or vehicle 104 moves in the transverse direction 1417.

Subsequently, the vehicle 100 may further classify the object or vehicle 104 as a specific vehicle class, determine start, end, length of the object and/or extract characteristic features such as axle number, number of vehicle occupants.

The system 100 may also adopt information items in relation to the vehicle position and speed from measuring units situated further away in space in order to carry out improved stitching.

Further, the system 100 may use structured illumination (for example, by means of a light or laser pattern emitted by the flash lighting unit 1420, for example in a striped or diamond form, into the illumination region 1425) in order to be able to extract an indication about optical distortions of the image of the vehicle 104, caused by the distance of the object or the vehicle 104, in the image from the image recording unit 112 by way of light or laser pattern structures known in advance and support the aforementioned gaining of information.

The system 100 may further be equipped with an illumination, for example in the visible and/or infrared spectral range, in order to assist the aforementioned gaining of information.

The described exemplary embodiments, which are also shown in the figures, are only selected in an exemplary manner. Different exemplary embodiments may be combined with one another in the totality thereof or in relation to individual features. Also, one exemplary embodiment may be complemented by features of a further exemplary embodiment.

Further, method steps according to the invention may be repeated and carried out in a sequence that differs from the described one.

If an exemplary embodiment comprises an “and/or” link between a first feature and a second feature, this should be read to mean that the exemplary embodiment comprises both the first feature and the second feature in accordance with one embodiment and, in accordance with a further embodiment, comprises only the first feature or only the second feature.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for counting axles of a vehicle on a lane in a contactless manner, wherein the method comprises the following steps:
reading first image data and reading second image data, wherein the first image data and/or the second image data represent image data from an image data recording sensor arranged at the side of the lane, said image data being provided at an interface, wherein the first image data and/or the second image data comprise an image of the vehicle;
editing the first image data and/or the second image data in order to obtain edited first image data and/or edited second image data, wherein at least one object is detected in the first image data and/or the second image data in a detecting sub-step using the first image data and/or the second image data and wherein an object information item representing the object and assigned to the first image data and/or second image data is provided and wherein the at least one object is tracked in time in the image data in a tracking sub-step using the object information item and wherein the at least one object is identified and/or classified in a classifying sub-step using the object information item; and
determining a number of axles of the vehicle and/or assigning the axles to static axles of the vehicle and rolling axles of the vehicle using the edited first image data and/or the edited second image data and/or the object information item assigned to the edited image data in order to count the axles of the vehicle in a contactless manner.

2. The method as claimed in claim 1, wherein, in the reading step, the first image data represent first image data captured at a first instant and the second image data represent image data captured at a second instant differing from the first instant.

3. The method as claimed in claim 2, wherein, in the reading step, further image data are read at the first instant and/or the second instant and/or a third instant differing from the first instant and/or the second instant, wherein the further image data represent an image information item captured by a stereo camera and/or a mono camera and/or a radar sensor system, wherein, in the editing step, the image data and the further image data are edited in order to obtain edited image data and/or further edited image data.

4. The method as claimed in one of the preceding claims, wherein the editing step comprises a step of homographic rectification, in which the image data and/or image data derived therefrom are rectified in homographic fashion using the object information item and provided as edited image data such that a side view of the vehicle is rectified in homographic fashion in the edited image data.

5. The method as claimed in claim 1, wherein the editing step comprises a stitching step, wherein at least two items of image data are combined from the first image data and/or the second image data and/or first image data derived therefrom and/or second image data derived therefrom and/or using the object information item and said at least two items of image data are provided as first edited image data.

6. The method as claimed in claim 1, wherein the editing step comprises a step of fitting primitives in the first image data and/or in the second image data and/or first image data derived therefrom and/or second image data derived therefrom in order to provide a result of the fitted and/or adopted primitives as object information item.

7. The method as claimed in claim 1, wherein the editing step comprises a step of identifying radial symmetries in the first image data and/or in the second image data and/or first image data derived therefrom and/or second image data derived therefrom in order to provide a result of the identified radial symmetries as object information item.

8. The method as claimed in claim 1, wherein the editing step comprises a step of classifying a plurality of image regions using at least one classifier in the first image data and/or in the second image data and/or first image data derived therefrom and/or second image data derived therefrom in order to provide a result of the classified image regions as object information item.

9. The method as claimed in claim 1, wherein the editing step comprises a step of ascertaining contact patches on the lane using the first image data and/or the second image data and/or first image data derived therefrom and/or second image data derived therefrom in order to provide contact patches of the vehicle on the lane as object information item.

10. The method as claimed in claim 1, characterized in that first image data and second image data are read in the reading step, said image data representing image data which were recorded by an image data recording sensor arranged at the side of the lane.

11. The method as claimed in claim 1, characterized in that first image data and second image data are read in the reading step, said image data being recorded using a flash-lighting unit for improving the illumination of a capture region of the image data recording sensor.

12. The method as claimed in claim 1, characterized in that, further vehicle data of the vehicle passing the image data recording sensor are read in the reading step, wherein the number of axles is determined in the determining step using the read vehicle data.

13. An axle-counting apparatus for counting axles of a vehicle on a lane in a contactless manner, wherein the apparatus comprises the following features:
an interface for reading first image data and reading second image data, wherein the first image data and/or the second image data represent image data from an image data recording sensor arranged at the side of the lane, said image data being provided at an interface, wherein the first image data and/or the second image data comprise an image of the vehicle;
a device for editing the first image data and/or the second image data in order to obtain edited first image data and/or edited second image data, wherein at least one object is detected in the first image data and/or the second image data in a detecting device using the first image data and/or the second image data and wherein an object information item representing the object and assigned to the first image data and/or second image data is provided and wherein the at least one object is tracked in time in the image data in a tracking device using the object information item and wherein the at least one object is identified and/or classified in a classifying device using the object information item; and
a device for determining a number of axles of the vehicle and/or assigning the axles to static axles of the vehicle and rolling axles of the vehicle using the edited first image data and/or the edited second image data and/or the object information item assigned to the edited image data in order to count the axles of the vehicle in a contactless manner.

14. An axle-counting system for road traffic, wherein the axle-counting system comprises at least one image data recording sensor and an axle-counting apparatus as claimed in claim 13 in order to count axles of a vehicle on a lane in a contactless manner.

15. A computer program product comprising program code for carrying out the method as claimed in claim 1 when the program product is run on an apparatus and/or an axle-counting apparatus.
